(19) United States
(12) Patent Application Publication
(10) Pub. No.: US 2019/0348247 A1
(43) Pub. Date: Nov. 14, 2019

(54) ACTIVATIONLESS GETTERS AND METHOD OF THEIR INSTALLATION INTO VACUUM INSULATED GLAZING

(71) Applicant: MECHEM LAB LTD., Nesher (IL)

(72) Inventors: Konstantin CHUNTONOV, Migdal Haemek (IL); Boris VERBITSKY, Haifa (IL)

(73) Assignee: MECHEM LAB LTD., Nesher (IL)

(21) Appl. No.: 16/462,543

(22) PCT Filed: Apr. 20, 2017
(86) PCT No.: PCT/IB2017/052277

§ 371 Date: May 21, 2019

Related U.S. Application Data
(60) Provisional application No. 62/497,734, filed on Dec. 1, 2016.

(51) Int. Cl. H01J 7/18; E06B 3/66; F04B 37/04

(52) U.S. Cl. CPC H01J 7/183; C22C 24/00; F04B 37/04; E06B 3/6612

(57) ABSTRACT

Vacuum insulated glasses with activationless getters on the basis of Ba, Ca, Li, Mg, Na and Sr alloys, taken in ratios, where each component of the getter alloy reacts with active gases continuously and to the end are provided. The getter material in the form of granules of diameter 0.5 mm-1.5 mm is introduced into the getter housing of the window under vacuum after the completion of the assembly procedures including the heating of the glass panels. The getter housing has the shape and dimensions facilitating a maximum sorption efficiency of the getter material.

### I. FIELD OF THE INVENTION

The present invention relates to vacuum insulation glasses, particularly, to a method of maintaining vacuum in vacuum insulation glasses with the help of getter materials.

### II. BACKGROUND OF THE INVENTION

Vacuum insulation glasses (VIGs) represent by themselves a new field of application for getter materials. Windows with a vacuum gap between glass panels provide a new example of energy saving technical solutions, in that it becomes possible to eliminate almost completely such heat-transfer mechanisms as convection and thermal conductivity in one of the problematic elements of building constructions.

The only obstacle on the way to a wide commercialization of this kind of a product is the issue of the cost. The role of the getter material according to the present invention is to compensate the high expenses for VIG production by the advantage of a considerable increase of their lifetime.

The usage of getters in this application is economically advantageous if a simple relation is fulfilled,

Δt/t>Δn/n

where t is the life of a VIG without a getter, Δt is the increment of the VIG lifetime due to the getter, n are expenses for the production of a VIG without a getter, and Δn are expenses connected with the getter. The given inequality is a quantitative criterion of the efficiency of the innovation based on the employment of getters in the field of VIGs. Although this criterion looks quite obvious, for some reason none of the previous developers of VIGs have used it for the evaluation of their getter solutions. Therefore it is difficult to define the economical advantages of the invention of the prior art. In the following the purely technical side of these inventions is considered.

The analysis of the known getter solution shows that each of them has at least one specific drawback of its own and one common drawback. The latter arises from the fact that according to the prior art any getter placed inside of a VIG is subjected to a thermal treatment, which seriously damages the sorption potential of the getter material.

Outgassing of glass panels by pumping down at temperatures of 350-650° C. requires a heating of the peripherical regions of the panels during the hermetization of the windows and the thermal activation of the getter (which is usually combined with the thermal treatment) are the most common thermal procedures. Due to intensive outgassing of the glass during heating the gas pressure in the gap between the panels grows by orders of magnitude. The getters, which are located therein, are activated upon heating and are rapidly saturated with the gases which evolve from the glass.

This situation has nothing in common with the standard thermal activation, when high vacuum is created in the chamber before heating of the getter. If a getter is heated in the atmosphere of active gases it just fails. In the case of the so-called NEGs containing transition metals with increase of the temperature these getters are converted from adsorbents into absorbents and vigorously reacting with the large amounts of gases, which evolve from the glass, lose the ability to sorb them in the future, when the temperature is decreased to room temperature. If a barium EG serves as the getter, then the powder mixture of e. g. Al₄Ba+Ni reacts at 500±150° C. with the reactive gases even more vigorously than the transition metals and serious damage is all the more inevitable. In this case the procedure of flashing of the getter may not take place at all and for sure the major part of the gases sorbed by powder mixtures will be returned back into the VIG's vacuum space at heating of the mixture to 800° C.

Thus, it is a common drawback of the existing VIG technologies that the process of the thermal outgassing of the glass panels and the hermetization of the window are destructive of the getter thus weakening its sorption properties. This harmful influence on the getter becomes even stronger due to the poor design of the structures of VIGs. According to the prior art getter recesses are located near the entrance of the mouth of the pump. As a result, all the gas flows, which are emitted from the surfaces of the glass panels during their heating, in the process of pumping converge in the place, where the getter is located, and attack the getter.

The consideration of the specific drawbacks of the prior art also reveals the following disadvantages. It is stated in U.S. Pat. No. 4,683,154 that a getter of the composition ZrVFe produced in a form of a strip of 10 cm×0.3 cm×0.08 cm is capable of maintaining the performance of a vacuum window of 1 m² at an inside pressure of 10⁻⁵-10⁻⁶ torr for 20-30 years. The given statement is not well founded. In order to calculate the life span of a VIP it is necessary to know the sorption properties of a getter; however, the overall getter dimensions do not determine the sorption characteristics of the getter material even if its composition is known, because the microstructure and surface characteristics must also be considered.

In essence a similar error can be observed in U.S. Pat. No. 6,420,002, which also ignores the influence of the microstructure and surface characteristics of the getter material upon its sorption properties. The method described therein minimizes the area of the sorbing surface by melting the getter powder deposited on the substrate. The getter is thus turned into a continuous coating with a minimal surface area.

Further, although in US Pat. Appl. 2014/0034218, US Pat. Appl. 2014/0037869, US Pat. Appl. 2014/0037870, and US Pat. Appl. 2016/0193818 a promising step was made to replace getter adsorbents (NEGs) by getter reactants (barium EGs), there is some doubt that the change is really successful since barium EGs require thermal activation. It is questionable that miniature recesses in the body of glass panels can be a reliable position for Ba EGs, since during the flashing process the temperature there rises to ˜1200° C. for a few seconds, which is much higher than the temperatures at which the glass liquefies. Moreover, rapid local heating of glass to these high temperatures by the barium source which is located close to it creates serious risks due to the high affinity of Ba to glass. In well-known applications of Ba EGs like CRT, getter devices are placed in a safe distance from a glass wall with the help of a special antenna [M. Wutz, H. Adam, W. Walcher, K. Jousten. Handbuch Vakuumtechnik. Theorie and Praxis, 7. Auflage. Vieweg, Braunschweig/Wiesbaden, Germany, 2000].

Finally, the idea of a hybrid getter described in the mentioned three patent applications of 2014 cannot be considered a good one. Combining a Ba EG and a NEG in one getter recess does not provide any advantage in sorption respect because sorption capacity of barium at room temperature is by several orders of magnitude higher than that of transition metals and the number of gases which are sorbed by barium is larger [B. Ferrario. Chemical Pumping in Vacuum Technology. Vacuum, Vol. 47, 1966, pp. 363-370; K. Chuntonov, J. Setina. Reactive getters for MEMS applications. Vacuum, Vol. 123, 2016, pp. 42-48]. The production cost in the case of this combination are expected to grow significantly.

The present overview shows that an effective and reliable solution of the getter problem in VIGs has not been found yet. There are two reasons for this: first, all the attempts to solve it have been limited to getter devices and materials requiring thermal activation; second, the very technology in which a getter is put into a VIG before the thermal treatment of the glass panels and their sealing by an edge seal method is not leading to the expected performance. In this case the getter is inevitably subjected to the disruptive impact of the active gases arising from the glass upon its heating.

### III. SUMMARY OF THE INVENTION

The present invention is provided by the appended claims. Accordingly, the present invention relates to a method of charging an activationless getter material into a vacuum insulation glass, VIG, after hermetization of the glass panels, wherein the charging is performed under vacuum.

In one preferred embodiment of the method, the activationless getter material is charged into a housing of a vacuum insulation glass, VIG, via a mouth piece with a shoulder.

In one preferred embodiment of the method, the getter housing is an extended cylindrical channel, which enters into each of the panels to the depth of not more than 1.5 mm and extends along the entire width of the panel parallel to the edge of the peripheral zone.

In one preferred embodiment of the method, after charging of the activationless getter material this mouth piece is sealed under vacuum.

In one preferred embodiment of the method, the activationless getter material is in the form of granules or rough powder particles produced from multicomponent alloy, all components thereof are selected from the group, consisting of Ba, Ca, Li, Mg, Na, and Sr taken in ratios which exclude the appearance of passivating layers on the surface of the granules or particles.

In one preferred embodiment of the method, the granules are produced by quenching the droplets of a melt with a diameter from 0.5 to 1.5 mm in an inert medium.

In one preferred embodiment of the method, the rough powder particles are produced by milling of the monolithic ingot in high vacuum, having the average size from 0.5 to 1.5 mm

In one preferred embodiment of the method, the cast granules have the composition Ba0.2Ca0.2Mg0.3Na0.1Sr0.2.

In one preferred embodiment of the method, the cast granules have the composition Li0.50Ba0.12Ca0.18Mg0.04 Na0.04Sr0.12.

In one preferred embodiment of the method, the cast granules have the composition (Ba0.65Mg0.35)xNa1−x with x in the range 0.85≤x≤0.90 after vacuum evaporation of Na at temperatures of 250-3000 C are turned into porous granules of the composition Ba with 35 at % Mg.

The present invention also provides an activationless getter material for vacuum insulation glass, VIGs, in the form of granules or rough powder particles produced from multicomponent alloy, all components thereof are selected from the group, consisting of Ba, Ca, Li, Mg, Na, and Sr taken in ratios which exclude the appearance of passivating layers on the surface of the granules or particles.

In one preferred embodiment of the activationless getter material, the granules are produced by quenching the droplets of a melt with a diameter from 0.5 to 1.5 mm in an inert medium.

In one preferred embodiment of the activationless getter material, the rough powder particles are produced by milling of the monolithic ingot in high vacuum, having the average size from 0.5 to 1.5 mm.

In one preferred embodiment of the activationless getter material, the cast granules have the composition Ba0.2Ca0.2Mg0.3Na0.1Sr0.2.

In one preferred embodiment of the activationless getter material, the cast granules have the composition Li0.50Ba0.12Ca0.18Mg0.04 Na0.04Sr0.12.

In one preferred embodiment of the activationless getter material, the cast granules have the composition (Ba0.65Mg0.35)xNa1−x with x in the range 0.85≤x≤0.90 after vacuum evaporation of Na at temperatures of 250-3000 C are turned into porous granules of the composition Ba with 35 at % Mg.

The present invention is based mainly on two innovations, on using activationless getter materials and on changing the presently established sequence of the technological procedures in VIGs manufacturing. Regarding the first innovation, getters are produced from alloys containing Ba, Ca, Li, Mg, Na, Sr and no further components. The alloys of this kind do not require heating or cooling and sorb O₂, H₂O, N₂, CO, CO₂, H₂ and a number of other gases at room temperature continuously and to completion by way of the growth of a layer of chemical compounds on the getter surface [K. Chuntonov, S. Yatsenko. Getter Films for Small Vacuum Chambers. Recent Patents on Materials Science, Bentham Science Publishers, Vol. 6, No 1, 2013, pp. 29-39]. Regarding the second innovation, the introduction of the getter material inside a VIG is performed through the pump-out tube only after the completion of the procedure of outgassing of the glass panels and hermetization of the window by edge seal methods. After charging of the getter material the part of the pump-out tube belonging to the window (the mouth piece or Mundstück) is reliably sealed and the outside part of this tube is disconnected.

With these two steps together with certain changes of the design character it is possible to maintain the thermal insulating properties of the window for any reasonable period of time. In the described organization of the assembly process the getter material is not subjected to disruptive influence of the heated gases appearing during the thermal treatment of VIGs. At the same time the new design of the getter housing and the auxiliary filling tools enable filling getter housings with sorption material under conditions and in an amount which guarantee the planned lifespan of the vacuum window unit.

Activationless getter material, the new sequence of assembly of a vacuum window as well as a new getter housing in the form of a narrow extended channel in the bodies of the glass panels in their peripherical region improve not only the performance of the windows but also their aesthetic appearance hiding the channel with the getter and the mouth piece under the outside frame.

### IV. BRIEF DESCRIPTION OF THE DRAWINGS

FIG. 1. The conventional variant: a getter recess according to prior art with the new getter material.

FIG. 2. The structure of the getter housing and its location.

FIG. 3. A top view of the configuration of the window elements.

FIG. 4. The design of the charging chamber.

FIG. 5. The design of the container for granules.

FIG. 6. The modified variant of the panel.

### V. DETAILED DESCRIPTION OF THE INVENTION

Activationless getter alloys, which capture all atmospheric gases except noble gases at room temperature following the linear or the parabolic law, are vastly superior to any other gas sorbents used in VIPs applications. Among the mentioned alloys the most efficient variant with respect to sorption and from the point of view of production costs are multicomponent alloys containing Ba, Ca, Li, Mg, Na, Sr. They capture gases by way of chemical reactions with formation of non-volatile compounds. According to the classification of getter materials these alloys are named reactants [K. Chuntonov, A. Atlas, J. Setina, G. Douglass. Getters: From Classification to Materials Design. Journal of Materials Science and Chemical Engineering, 2016, Vol. 4, pp. 23-34].

In the present invention, the preference is given to these multicomponent reactants: cast granules of the composition Ba_{0.2}Ca_{0.2}Mg_{0.3}Na_{0.1}Sr_{0.2} with the diameter of 0.5-1.5 mm and obtained in inert medium from the melt by the droplet casting method [K. Chuntonov. Apparatus and method for droplet casting of reactive metals and its applications. U.S. Pat. No. 9,339,869]; cast granules of the composition Li_{0.50}Ba_{0.12}Ca_{0.18}Mg_{0.04}Sr_{0.12}Na_{0.04} of the same size and produced by the same method as the previous product; porous granules of the composition Ba—35 at % Mg produced by quenching of droplets of the melts (Ba_{0.65}Mg_{0.35})ₓ(Na₁₋ₓ, where 0.85≤x≤0.90 subjected to vacuum evaporation of Na at 200-300° C. The average size of the binary porous granules is close to the size of multicomponent granules.

However, the list of getter reactants suitable for being used in VIGs is not limited to the above mentioned granulated materials. Ribbons or wires of the composition Li_{0.89}Ba_{0.03}Ca_{0.03}Sr_{0.03}Na_{0.02} produced from the ingots of the same composition by extrusion at room temperature are also strong gas sorbents. Other similar products also belong to this group except the materials with the dominative presence of Mg, which is inclined to passivation.

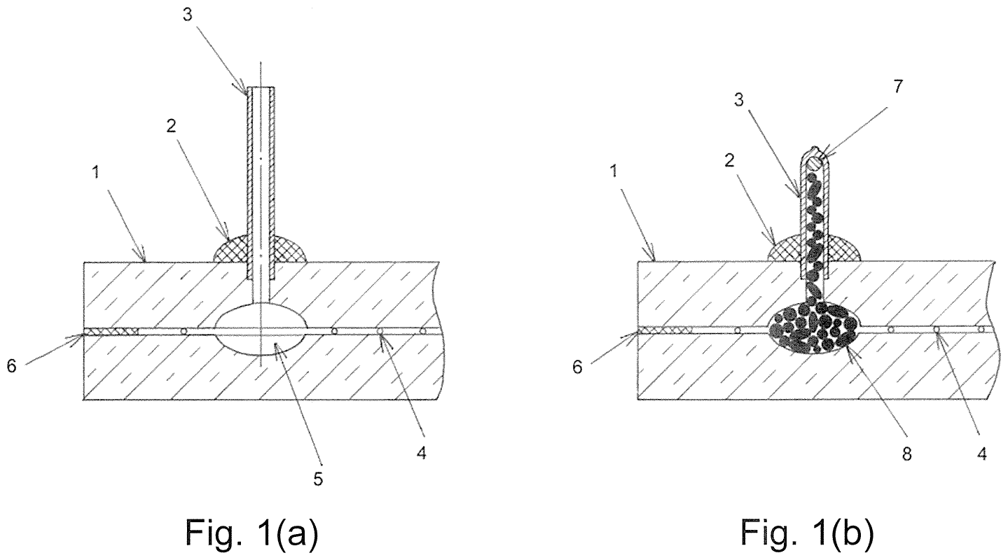

Reactants of the granule type could be used in the current designs of VIGs (FIG. 1) by filling the sorbent 8 into getter recess 5 at the final stage of production, i.e. after the thermal outgassing of the panels and their hermetical joining along the edge of these panels by any reliable method. After filling with getter material under vacuum the glass tube 3 is sealed-off close to the surface of panel 1 (FIG. 1b). However, this solution is not reliable because the shape and the volume of the getter recess typical for the prior art are far from those which are recommended by vacuum theory and practice.

The lifespan of sealed-off vacuum vessels, to which VIGs belong, is determined by the following values: by the rate, with which the gas gets into the vessel volume (leakage rate), as well as by the sorption properties of the getter, that is, its gettering rate, which is the higher the larger the surface of the getter body is, and by its sorption capacity, which is proportional to the volume of the reactants. The approximate idea about the ratio between the volume and the surface of the getter material in sealed glass vessels with a lifespan of 20-30 years under a vacuum not lower than 10⁻⁶ mbar can be obtained if we address to the positive experience with television CRT.

According to this experience an average size of a Ba EG with 200 mg of a barium yield of ˜200 mg, which apparently fits the getter recess of the considered type (FIG. 1), with deposition forms a “barium mirror” with a surface area of several hundred square centimeters [M. Wutz, H. Adam, W. Walcher, K. Jousten. Handbuch Vakuumtechnik. Theorie und Praxis, 7. Auflage. Vieweg, Braunschweig/Wiesbaden, Germany, 2000]. This shows that an attempt to build a Ba EG into a getter recess will not give a desirable effect because in this case the getter film will be ˜100 times smaller in area than required. If a getter recess is filled with granules of reactants the getter surface area would be by ˜10 times smaller than required.

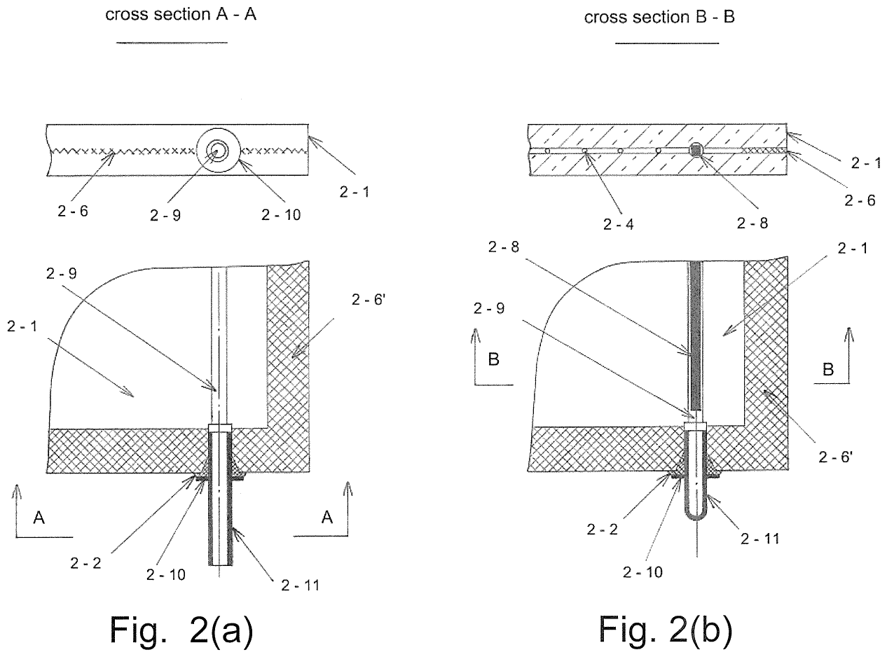

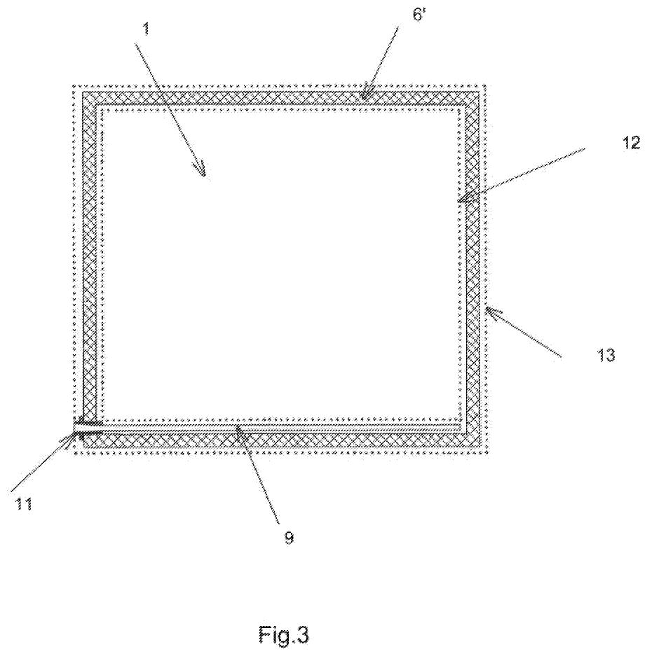

This means that the size and shape of getter housings for long lasting VIGs must be adjusted to accommodate getter bodies with large values of the ratio s/v, where s is the area of the apparent (geometrical) surface of the getter and v is the volume of the getter. This is a requirement connected with the kinetics of the sorption process and it is taken into consideration in the new getter housing (FIG. 2), which forms an extended channel with a round cross-section. This channel with a diameter of 1.5-4.5 mm, preferably 2.5-3.5 mm, more preferably 3 mm is equally inserted between both panels, each of them being 4 mm thick, and takes almost the entire width of the window (FIG. 3), e.g. but not limiting in its lower part. The channel can also have a square cross section, e.g. 1.5-4.5 mm×1.5-4.5 mm, preferably 2.5-3.5 mm×2.5-3.5 mm, more preferably 3.0 mm×3.0 mm.

Getter channel 9 (FIG. 2a) is connected to the vacuum line via a glass mouth piece 11, which is used also for filling channel 9 with the getter material. Supporting shoulder 10 on the mouth piece 11 facilitates fixing the mouth piece on the edge of panels 1; this shoulder also helps filling the widened conical entrance into channel 9 with sealing material 2. The process of hermetization of this joint, i.e. the joint between the panels and the mouth piece, can be synchronized with sealing the panels 1 to each other in zone 6 (on the periphery of the window). The mouth piece can be glass or metallic. In the latter case for its sealing-off a pinching method can be used as an example.

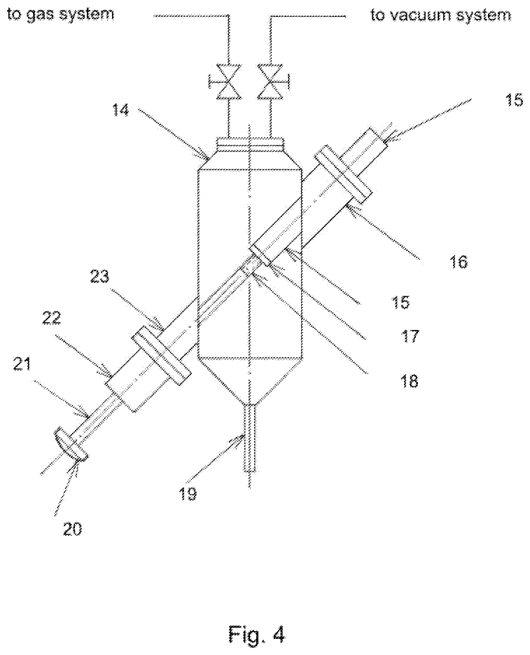

A glove box with an atmosphere of pure argon and a metal charging chamber 14 (FIG. 4) with five ports are used for transporting the getter material to the VIG. The first two ports provide the connections of the chamber to the vacuum and gas systems, the third port 16 serves for introduction of container 15 with the getter material into the chamber, the fourth port 19 serves for connecting chamber 14 with the VIG via mouth piece 11 (FIG. 2) and, finally, the last port 23 is used for manipulations e.g. for pulling plug 17 of container 15 by means of a rotary/linear feedthrough 22.

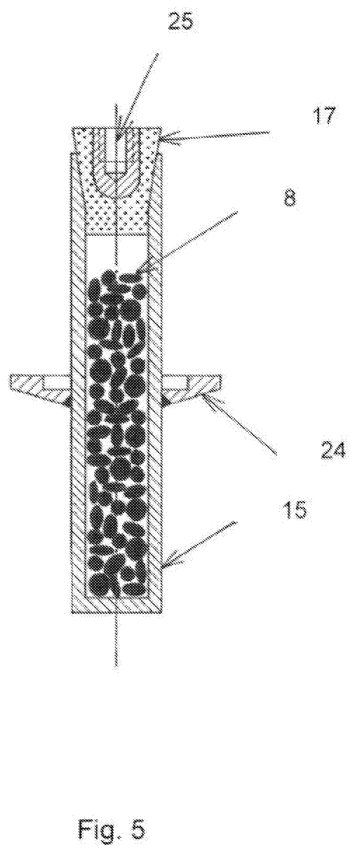

Container 15 (FIG. 5) is filled with getter material 8 in the glove box under argon and tightly closed with the conical rubber plug 17 pressing the plug from above. Then container 15 is taken out of the glove box and introduced into the charging chamber in an inclined position with the plug down as shown in FIG. 4. After that the lower tube 19 of chamber 14 (FIG. 4) is connected with the mouth piece 11 (FIG. 2) and the air from the chamber is pumped down as well as from the VIG.

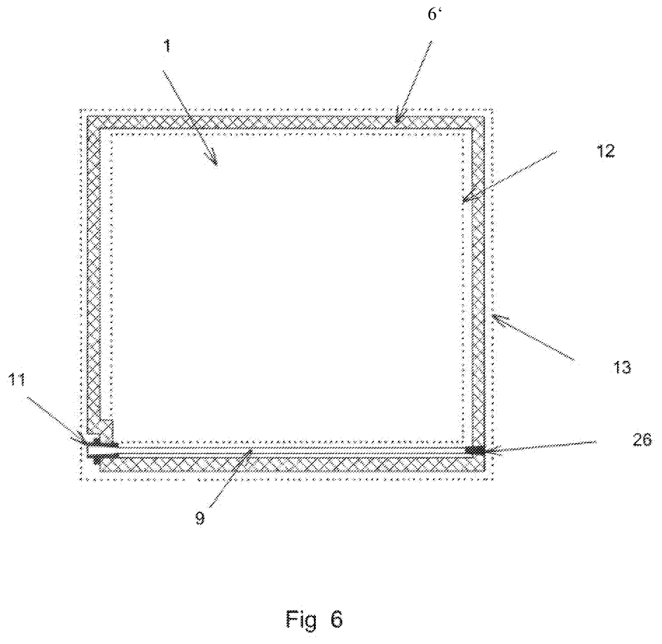

Before charging the granules into the VIG its vacuum space and chamber 14 (FIG. 4) are cleaned with argon fed from the gas line and then pumped down again. This procedure is repeated several times. Then with the help of handle 20 shaft 21 (with thread 18 at the end) is inserted into plug 17, which has a metal socket with thread 25 (FIG. 5) in its central part. Applying axial force plug 17 is slowly pulled out from container 15 letting out first the argon and then the granules of the sorbent, which poring through tube 19 (FIG. 4) and the mouth piece 11 get into channel 9 (FIGS. 2a, 3). After the filling procedure is completed the mouth piece is sealed-off near the window edge (FIG. 2b), plug 17 is returned back by a linear movement of the shaft 21 to its place in container 15 (FIG. 4) and, finally, shaft 21 is released from the plug using a rotation movement. From this moment container 15 is ready for the transfer into the glove box for the next portion of granules and the VIG is ready for the assembly of the outside frame 12/13 (FIGS. 3, 6).

Concerning the frames, the remaining part of the mouth piece (FIG. 2b), which protrudes beyond the contour, can be “sunk” in the original position (FIG. 6) if a small part of the panel is removed from a corner. Channel 9 can be produced by different methods, e. g. by making an extended groove on each of the two panels by mechanical, thermal or chemical treatment. It can be obtained also by making through grooves at the stage of the production of the panels themselves. In the last case, after the assembly of the panels one of the exits of channel 9 is hermetically closed with the glass plug 26 (FIG. 6).

### VI. DETAILED DESCRIPTION OF THE DRAWINGS

FIG. 1. A hypothetical model: a getter recess according to the prior art with the new getter material.

(a) before filling with the granules of the reactant; (b) after filling with the granules and sealing-off;
1—a glass panel
2—sealing material,
3—a pump-out tube,
4—pillars,
5—a getter recess,
6—a hermetic seam,
7—an insulating ball,
8—granules of reactants.

FIG. 2. The structure of the getter housing and its location.

(a) before filling with the reactant; (b) after filling with the reactant and sealing-off;
1—a glass panel,
2—sealing material,
3—a pump-out tube,
4—pillars,
6—a hermetic seam,
6′—the hermetic seam zone,
8—the reactant,
9—a getter channel,
10—a shoulder,
11—a mouth piece.

The nearness of the channel for the getter to the edge of the panel 1 is clearly seen as well as the role of the shoulder 10 as the element fixing the position of the mouth piece 11 upon assembling.

FIG. 3. A top view of the configuration of the window elements.
1—a glass panel,
6′—the hermetic seam zone,
9—a getter channel,
11—a mouth piece,
12—an inside border of the frame,
13—an outside border of the frame.

FIG. 4. The principle scheme of the charging chamber.
14—a metallic casing,
15—a container for the granules of the reactant,
16—a port with the flange for the insertion of container
15, 17—a rubber plug in the container,
18—thread on the end of shaft
21, 19—a tube for pouring the granules into the VIG,
20—a handle for linear/rotary motion,
21—a shaft,
22—a feedthrough,
23—a port with a flange for linear/rotary motion.

Tube 19 can be connected with mouth piece 11 (FIG. 2a) both butt-to-butt using a rubber tube, which is put on connected parts for the insulation from the atmosphere, or by a flange-to-flange method using suitable adaptors.

FIG. 5. The design of the container for granules.
8—granules of the reactant,
15—a metallic cartridge,
17—a conical rubber plug,
24—a flange welded to the cartridge,
25—a metallic socket fused into the plug with thread.

FIG. 6. The modified variant of the panel.
1—a glass panel,
6′—the hermetic seam zone,
9—a getter channel,
11—a mouth piece,
12—an inside border of the frame,
13—an outside border of the frame,
26—a hermetized glass plug.

The end-to-end channel is closed with plug 26 at the stage of the window assembly. Another difference from the earlier discussed solutions (FIG. 3) is a small niche in the lower corner of the panel, which is made for hiding the mouth piece under the frame without increasing the dimensions of the frame.

### CONCLUSION

The technology described above provides an improved solution of the VIGs problem over that suggested by the prior art. Its advantages are the result of the innovations listed below.
1. The sequence of the assembly steps of the window has been reconsidered. The getter is introduced into the VIG only after the thermal outgassing of the glass and sealing of the panels. The getter material is thus protected from the damaging impact of active gases which are released when the glass is heated, leading to a prolonging the lifespan of the VIG.
2. The design of the getter housing and its location in the lower part of the window has been optimized regarding the gas sorption performance. The getter housing in the form of an extended narrow channel enhances the sorption efficiency of the getter contained therein due to both the general increase of the volume of the housing and to an increase of the ratio s/v of the getter material. At the same time the location of the channel close to the lower edge of the panel allows to hide it under the outside frame as well to avoid the spreading of the powders of the products of the sorption process in the total volume of the VIG. This improves the esthetic appearance of the window.
3. Activationless getter reactants are filled into the VIG under vacuum, which simplifies the assembly process and increases the lifetime of the vacuum window. The simplification arises from the fact that no thermal activation is necessary by principle, and that the thermal outgassing of the panels can be cancelled because the getter reactants easily cope with this job. Calculations have shown that when the entire channel 9 (FIG. 2, 3), which is 0.8 m long and 3 mm in diameter, is filled with getter granules, the total getter mass by far exceeds the required minimum , which is necessary for the normal performance of a window of 1 m² with a vacuum gap of 0.2 mm during 20 years. The reactants make it possible to greatly decrease the production costs, since all kinds of thermal procedures except those, in which heating is used to support the hermetization processes, are unnecessary.

### OTHER EMBODIMENTS

The following description provides alternative formulations of the present disclosure.

According to the present disclosure, a method for producing activationless getters for vacuum insulation glasses, VIGs, not only in the form of cast granules but also in the form of rough powder particles produced by mechanical milling of monolithic ingots in high vacuum is provided. These granules or particles with a diameter or an average size from 0.5 to 1.5 mm are produced from a multicomponent alloy consisting of Ba, Ca, Li, Mg, Na, and Sr taken in ratios which exclude the appearance of passivating layers. Thus the alloy preferably does not contain more than 30 mol % and more preferably not more than 20 mol % of Mg.

Rough powder particles are produced in high vacuum with the help of the milling mechanism described in US Patent Application 20160045855. In this case instead of the container 15 (FIG. 5) an evacuated glass ampoule with the particles of the getter alloy is introduced into the charging chamber 14, where after opening the ampoule mechanically, the said particles pour into the VIG.

1. Method of charging an activationless getter material into a vacuum insulation glass, VIG, after hermetization of the glass panels, wherein the charging is performed under vacuum.

2. The method according to claim 1, wherein the activationless getter material is charged into a housing of the vacuum insulation glass, VIG, via a mouth piece with a shoulder.

3. The method according to claim 2, where the housing is an extended cylindrical channel, which enters into each of the glass panels to the depth of not more than 1.5 mm and extends along the entire width of the glass panels parallel to the edge of the peripheral zone.

4. The method according to claim 2, wherein after charging of the activationless getter material, the mouth piece is sealed under vacuum.

5. The method according to claim 1, wherein the activationless getter material is in the form of granules or rough powder particles produced from multicomponent alloy including components selected from the group consisting of Ba, Ca, Li, Mg, Na, and Sr taken in ratios which exclude the appearance of passivating layers on the surface of the granules or particles.

6. The method according to claim 5, wherein the granules are produced by quenching droplets of a melt with a diameter from 0.5 to 1.5 mm in an inert medium.

7. The method according to claim 5, wherein the rough powder particles are produced by milling of a monolithic ingot in high vacuum, having an average size from 0.5 to 1.5 mm.

8. The method according to claim 5, wherein the cast granules have the composition Ba_{0.2}Ca_{0.2}Mg_{0.3}Na_{0.1}Sr_{0.2}.

9. The method according to claim 5, wherein the cast granules have the composition Li_{0.50}Ba_{0.12}Ca_{0.18}Mg_{0.04}Na_{0.04}Sr_{0.12}.

10. The method according to claim 5, wherein the cast granules have the composition (Ba_{0.65}Mg_{0.35})ₓNa₁₋ₓ with x in the range 0.85≤x≤0.90 after vacuum evaporation of Na at temperatures of 250-300° C. are turned into porous granules of the composition Ba with 35 at % Mg.

11. Activationless getter material for vacuum insulation glass, VIGs, in the form of granules or rough powder particles produced from multicomponent alloy including components selected from the group consisting of Ba, Ca, Li, Mg, Na, and Sr taken in ratios which exclude the appearance of passivating layers on the surface of the granules or particles.

12. The activationless getter material according to claim 11, wherein the granules are produced by quenching droplets of a melt with a diameter from 0.5 to 1.5 mm in an inert medium.

13. The activationless getter material according to claim 11, wherein the rough powder particles are produced by milling of a monolithic ingot in high vacuum, having an average size from 0.5 to 1.5 mm.

14. The activationless getter material according to claim 11, wherein the cast granules have the composition Ba_{0.2}Ca_{0.2}Mg_{0.3}Na_{0.1}Sr_{0.2}.

15. The activationless getter material according to claim 11, wherein the cast granules have the composition Li_{0.50}Ba_{0.12}Ca_{0.18}Mg_{0.04}Na_{0.04}Sr_{0.12}.

16. The activationless getter material according to claim 11, wherein the cast granules have the composition (Ba_{0.65}Mg_{0.35})ₓNa₁₋ₓ with x in the range 0.85≤x≤0.90 after vacuum evaporation of Na at temperatures of 250-300° C. are turned into porous granules of the composition Ba with 35 at % Mg.
